(19) United States
(12) Patent Application Publication
(10) Pub. No.: US 2025/0156306 A1
(43) Pub. Date: May 15, 2025

(54) METHOD AND DEVICE FOR DENOISING TEST DATA, STORAGE MEDIUM AND COMPUTER DEVICE

(71) Applicant: GUANGZHOU PINWEI SOFTWARE CO., LTD., Guangzhou (CN)

(72) Inventor: Wei XU, Guangzhou (CN)

(73) Assignee: GUANGZHOU PINWEI SOFTWARE CO., LTD., Guangzhou (CN)

(21) Appl. No.: 18/737,939

(22) Filed: Jun. 7, 2024

(30) Foreign Application Priority Data
Nov. 13, 2023 (CN) 202311499034.5

(51) Int. Cl. G06F 11/36

(52) U.S. Cl. CPC G06F 11/3684

(57) ABSTRACT

A method for denoising test data, a device for denoising test data, a storage media and a computer device are provided. For any replaying mobile terminal different from a recording mobile terminal, first request data and first response data are obtained in responds to a replaying request for a target test case, where the first response data is the same as response data for recording the target test case. Then, in a case that a preset request field corresponding to the target test case is identified in the first request data, a target value corresponding to a preset response field is generated. Ultimately, a value of a response field matching the preset response field in the first response data is replaced with the target value.

### CROSS REFERENCE OF RELATED APPLICATION

This application claims priority to Chinese Patent Application No. 202311499034.5, titled “METHOD AND DEVICE FOR DENOISING TEST DATA, STORAGE MEDIUM AND COMPUTER DEVICE”, filed on Nov. 13, 2023 with the China National Intellectual Property Administration, which is incorporated herein by reference in its entirety.

### FIELD

The present disclosure relates to the technical field of software testing, and in particular to a method for denoising test data, a device for denoising test data, a storage medium and a computer device.

### BACKGROUND

In the process of software development, due to frequent changes of the requirements of service functions of the software, traffic recording and replaying are adopted to test the service functions to reduce the time spent in creating test cases. Generally, traffic recording and replaying are performed by copying recorded traffic data and then simulating replay in a test environment. In practical software development, the software is generally applied to different mobile terminals, where different mobile terminals may involve different computing platforms or different manufacturers, etc. In a case that a test case is replayed on a mobile terminal, i.e., a replaying mobile terminal, that is different from the one on which the test case was recorded, i.e., a recording mobile terminal, the test case replay may fail due to differences between the mobile terminals.

### SUMMARY

In the present disclosure, there is an interest in considering at least one of the above problems, particularly the problem in the conventional technology where test case replay fails due to differences between mobile terminals when a test case is replayed on the replaying mobile terminal different from the recording mobile terminal.

In a first aspect, a method for denoising test data is provided according to an embodiment of the present disclosure, the method includes:
obtaining, for a replaying mobile terminal different from a recording mobile terminal, replaying traffic data in response to a replaying request for a target test case, where the replaying traffic data includes first request data and first response data, the first response data is the same as second response data, and the second response data is response data for recording the target test case;
generating a target value corresponding to a preset response field, in a case that a preset request field corresponding to the target test case is identified in the first request data, where the preset response field corresponds to the preset request field in the first request data, and the preset response field is a noise field; and
replacing a value of a response field matching the preset response field in the first response data with the target value, to eliminate interference caused by the noise field during a process of replaying the target test case and enable the first response data with replacement to be applicable to the replaying mobile terminal;
where a generation process of the preset request field and the preset response field corresponding to the target test case includes:
obtaining recorded traffic data corresponding to the target test case from a server, where the recorded traffic data includes the second response data and second request data;
parsing the second request data;
determining requirement information corresponding to the target test case from a test requirement set, where the test requirement set is used to record all the requirement information of a target application;
determining the preset request field from request fields of the second request data based on the requirement information corresponding to the target test case;
determining the preset response field from response fields of the second response data based on the requirement information corresponding to the target test case; and
associating the preset request field with the preset response field to obtain a first association relationship.

In an embodiment, the process of generating the target value corresponding to the preset response field in a case that the preset request field corresponding to the target test case is identified in the first request data includes:

determining, in the case that the preset request field corresponding to the target test case is identified in the first request data, the preset response field corresponding to the preset request field based on the first association relationship; and generating the target value corresponding to the preset response field.

In an embodiment, the process of generating the target value corresponding to the preset response field includes: generating the target value corresponding to the preset response field based on an assignment rule corresponding to the preset response field.

In an embodiment, the assignment rule includes a random rule; the process of generating the target value corresponding to the preset response field based on the assignment rule corresponding to the preset response field includes: generating a value randomly as the target value corresponding to the preset response field, in a case that the assignment rule corresponding to the preset response field is the random rule.

In an embodiment, the assignment rule includes a preset rule; the process of generating the target value corresponding to the preset response field based on the assignment rule corresponding to the preset response field includes: generating a value that satisfies the preset rule as the target value corresponding to the preset response field, in a case that the assignment rule corresponding to the preset response field is the preset rule, where the preset rule includes a data type and a value range.

In a second aspect, a device for denoising test data is provided according to an embodiment of the present disclosure, the device includes:
a test case replaying module, configured to obtain replaying traffic data for a replaying mobile terminal different from a recording mobile terminal in response to a replaying request of a target test case, where the replaying traffic data includes first request data and first response data, the first response data is the same as second response data, and the second response data is response data for recording the target test case;
a target value generation module, configured to generate a target value corresponding to a preset response field in a case that a preset request field corresponding to the target test case is identified in the first request data, where the preset response field corresponds to the preset request field in the first request data, and the preset response field is a noise field; and
a target value replacement module, configured to replace a value of a response field matching the preset response field in the first response data with the target value to eliminate interference caused by the noise field during a process of replaying the target test case and enable the first response data with replacement to be applicable to the replaying mobile terminal;
where the device for denoising test data further includes:
a recording data obtaining module, configured to obtain recorded traffic data corresponding to the target test case from a server, where the recorded traffic data includes the second response data and second request data;
a preset field determination module, configured to parse the second request data, and determine requirement information corresponding to the target test case from a test requirement set, where the test requirement set is used to record all the requirement information of a target application; and determine the preset request field from request fields of the second request data and the preset response field from response fields of the second response data based on the requirement information corresponding to the target test case; and
a preset field association module, configured to associate the preset request field with the preset response field to obtain a first association relationship.

In a third aspect, a storage medium is provided according to an embodiment of the present disclosure, the storage medium stores computer-readable instructions. The computer-readable instructions, when executed by one or more processors, cause one or more processors to implement the method for denoising test data according to any one of the above embodiments.

In a fourth aspect, a computer device is provided according to an embodiment of the present disclosure, including one or more processors, and a memory. Where, the memory stores computer-readable instructions, and the computer-readable instructions, when executed by one or more processors, implement the method for denoising test data according to any one of the above embodiments.

### BRIEF DESCRIPTION OF THE DRAWINGS

In order to more clearly describe technical solutions in the embodiments of the present disclosure or in the conventional technology, drawings to be used in the description of the embodiments or the conventional technology are briefly described hereinafter. It is apparent that the drawings described below demonstrate merely some embodiments of the present disclosure, and those skilled in the art can obtain other drawings based on the provided drawings without any creative effort.

FIG. 1 is a schematic flowchart of a method for denoising test data according to an embodiment of the present disclosure;

FIG. 2 is a schematic diagram of modules of a device for denoising test data according to an embodiment of the present disclosure; and

FIG. 3 is a schematic diagram of an internal structure of a computer device according to an embodiment of the present disclosure.

### DETAILED DESCRIPTION OF THE EMBODIMENTS

Technical solutions in the embodiments of the present disclosure are clearly and thoroughly described below in conjunction with the drawings of the embodiments of the present disclosure. Apparently, the embodiments described below are only some embodiments of the present disclosure, rather than all the embodiments. Any other embodiments obtained by those skilled in the art based on the embodiments in the present disclosure without any creative effort fall within the protection scope of the present disclosure.

In the process of software development, due to frequent changes of the requirements of each service function of the software, it is required to test each service function through traffic recording and replaying to reduce the time spent in creating test cases. Generally, traffic recording and replaying are performed by copying recorded traffic data and then simulating replay in a test environment. In practical software development, the software is generally applied to different mobile terminals. Different mobile terminals may involve different terminal platforms or different manufacturers, etc. In a case of testing different mobile terminals through the conventional method for recording and replaying traffic, it is required to record traffic data on different mobile terminals and then simulate replay on each mobile terminal. In other words, the same service function must be replayed on each mobile terminal at least once. This conventional method of recording and replaying traffic is a back-end test oriented towards an application interface. It involves collecting online traffic and replaying this traffic in a test environment to obtain a test result, which is then used to determine if there is a problem with the interface code. This process increases the testing workload and compromises testing efficiency.

Therefore, in order to reduce the testing workload, it is generally expected that the test case can be replayed on any mobile terminal after being recorded on one mobile terminal. In other words, it is expected that the response data received by the recording mobile terminal can be applied to the replaying mobile terminal, so that an interface display effect of the replaying mobile terminal is consistent with an interface display effect of the recording mobile terminal for the same test case. This ideal method for recording and replaying the traffic is a front-end test oriented towards a software interface, and generally intervenes to perform the test after normal function of the interface is ensured by the back-end test. In practical process of replaying of the test case, however, the difference between the recording mobile terminal and the replaying mobile terminal may lead to a difference between recorded request data and replayed request data, causing values of part of the response fields in the recorded response data cannot be applied in the replaying mobile terminal. In embodiments of the present disclosure, the response field whose value may be invalid is referred as a noise field. The noise fields cause failure of replaying test cases and reduce the efficiency of replaying test cases.

In view of this, according to the present disclosure, technical solutions are provided as follows.

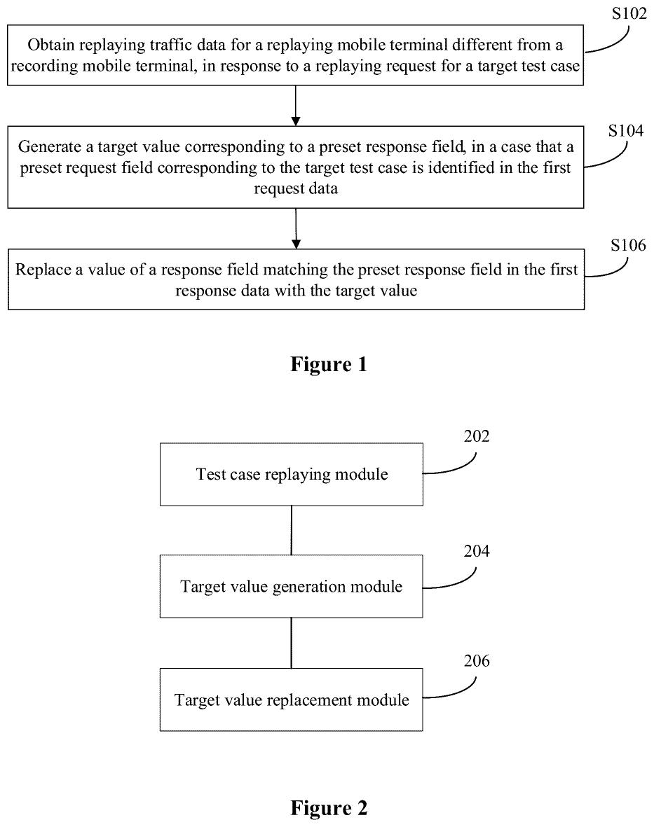

In a first aspect, according to an embodiment of the present disclosure, a method for denoising test data is provided. Reference is made to FIG. 1. FIG. 1 illustrates a schematic flowchart of a method for denoising test data. The method includes steps S102 to S106 as follows.

In step S102, for a replaying mobile terminal different from a recording mobile terminal, replaying traffic data is obtained in response to a replaying request for a target test case.

In this step, before the target test case is replayed at the replaying mobile terminal, the recording mobile terminal obtains recorded traffic data in response to the recording request for the target test case, and stores the recorded traffic data in the server. Where, the recorded traffic data includes second request data and second response data. For any replaying mobile terminal different from the recording mobile terminal, the replaying mobile terminal obtains the replaying traffic data after receiving the replaying request for the target test case. Where, the replaying traffic data includes first request data and first response data, the first response data is the same as the second response data, and the second response data is a response data for recording the target test case.

It should be understood that the recording mobile terminal is a mobile terminal for recording the target test case, and the replaying mobile terminal is a mobile terminal for replaying the target test case. Any replaying mobile terminal different from the recording mobile terminal indicates that there is a difference between the recording mobile terminal and the replaying mobile terminal. The difference between the recording mobile terminal and the replaying mobile terminal causes an interface effect displayed at the recording mobile terminal to be inconsistent with an interface effect displayed at the replaying mobile terminal while executing the target test case. Where, the difference between the recording mobile terminal and the replaying mobile terminal may reflect in operation system of the mobile terminal, such as iOS, Android, Harmony OS, etc. The difference may also reflects in resolution of the mobile terminal, which may be determined by the manufacturer of the mobile terminal and the model of the mobile terminal.

It should be understood that the first request data is the request data for replaying the target test case, and the first request data includes more than one request field, and each request field corresponds to a value. The first response data is the response data for replaying the target test case, the first response data includes more than one response field, and each response field corresponds to a value. The second request data is the request data for recording the target test case, and the second request data includes more than one request field, and each request field corresponds to a value. The second response data is the response data for recording the target test case, the second response data includes more than one response field, and each response field response field corresponds to a value.

Further, the request data is traffic data generated and sent by the mobile terminal, and the response data is traffic data received by the mobile terminal after sending the request data. Therefore, the first response data being the same as the second response data indicates that the traffic data received by the replaying mobile terminal is the same as the traffic data received by the recording mobile terminal. In a case that the first response data is the same as the second response data, assuming that front-end code of the target application program is correct, the interface effect of the target test case displayed on the replaying mobile terminal can indicate a test result at the front-end. In a case that there is no difference between the recording mobile terminal and the replaying mobile terminal, the interface effect of the target test case displayed on the replaying mobile terminal is consistent with the interface effect displayed on the recording mobile terminal, indicating that the target test case has been successfully tested. In a case that there is a difference between the recording mobile terminal and the replaying mobile terminal, the interface effect of the target test case displayed on the replaying mobile terminal is inconsistent with the interface effect displayed on the recording mobile terminal, indicating that the failure of the target test case. When testing the front-end in practical process, if the interface effect of the target test case displayed on the replaying mobile terminal is inconsistent with the interface effect of the target test case displayed on the recording mobile terminal, without affirming the correctness of the front-end code, it, in fact, cannot be determined whether such inconsistency is due to the difference between the recording mobile terminal and the replaying mobile terminal or an issue with the front-end code. Therefore, to determine the cause of the test failure for the target test case, step S104 is performed to eliminate any differences between the recording mobile terminal and the replaying mobile terminal.

In an embodiment, in response to the replaying request for the target test case, the replaying mobile terminal generates first request data and sends the first request data to the server. The server may send a piece of response data back to the replaying mobile terminal. Before the replaying mobile terminal receives the response data, a simulation server intercepts the response data and replicates the second response data to replace the response data. The server may further identify the corresponding target test case through the first request data, and replicate the second response data of the target test case to feed back to the replaying mobile terminal.

In step S104, in a case that a preset request field corresponding to the target test case is identified in the first request data, a target value corresponding to a preset response field is generated.

In this step, before the preset request field corresponding to the target test case is identified in the first request data, it is required to identify whether there is a preset request field corresponding to the target test case in the first request data. In a case that there is a preset request field corresponding to the target test case in the first request data, it indicates that there is a request field in the first request data that could prevent the first response data from being applicable to the replaying mobile terminal. Therefore, it is required to generate the target value corresponding to the preset response field. Otherwise, it indicates that there is no request field in the first request data that would prevent the first response data from being applicable to the replaying mobile terminal, i.e., the current first response data can be effective on the replaying mobile terminal. Where, the preset response field corresponds to the preset request field in the first request data.

It should be understood that the preset request field refers to a request field changed due to the difference between the recording mobile terminal and the replaying mobile terminal, which may be configured based on the requirement information of the target application. Each test case corresponds to a different preset request field. The preset response field refers to a response field in the target test case that changed due to the change of the preset request field, which may further be configured based on the requirement information of the target application. Since each test case corresponds to a different preset request field, each test case corresponds to a different preset response field. According to an embodiment of the present disclosure, the preset response field may be referred to as the noise field.

As an example, in a case that the preset request field of the target test case is “OS”, and the preset response field is “off” and “current price”. In a case that the first request data is {OS: iOS, id: 1}, a preset request field corresponding to the target test case may be identified in the first request data, indicating that the “off: 50%, current price: 5” in the first response data {id: 1, name: paper, cost price: 10, off: 50%, current price: 5} may not be applied to the replaying mobile terminal. Therefore, target values corresponding to “off” and “current price” are required to be generated to ensure that “off” and “current price” are effective on the replaying mobile terminal.

In step S106, a value of the response field matching the preset response field in the first response data is replaced with a target value.

It should be understood that the first response data is the same as the second response data, that is, the response field of the first response data and the value corresponding to the response field of the first response data are completely identical to the response field of the second response data and the value corresponding to the response field of the second response data. In step S104, the preset request field corresponding to the target test case is identified in the first request data, indicating that noise fields in the current first response data could cause failure of replaying the target test case. Therefore, the value of the response field matching the preset response field in the first response data may be replaced with the target value, to ensure the integrity and validity of the first response data, thereby eliminating the interference caused by the noise fields when replaying the target test case.

Based on any one of the above embodiments, for any replaying mobile terminal different from the recording mobile terminal, the first request data and the first response data for replaying traffic data are obtained in response to the replaying request for the target test case. The first response data is the same as the response data for recording the target test case. Then, in a case that a preset request field corresponding to the target test case is identified in the first request data, a target value corresponding to the preset response field is generated, where the preset response field is corresponding to the preset request field. Ultimately, the value of the response field matching the preset response field in the first response data is replaced with the target value. According to the present disclosure, in a case that a preset request field corresponding to the target test case is identified in the first request data, it can be determined that a preset response field corresponding to the preset request field is included in the current first response data. The target value corresponding to the preset response field is generated, and the value of the response field matching the preset response field in the first response data is replaced with the target value. In this way, it can ensure that the first response data with replacement can be applicable to the replaying mobile terminal. Therefore, in a case that the test case is replayed on any replaying mobile terminal, the interference caused by the difference between mobile terminals can be eliminated, ensuring effectiveness of replaying traffic data, and improving efficiency of replaying test cases.

In an embodiment, the generation process of the preset request field and the preset response field corresponding to the target test case includes steps as follows.

In step a, the recorded traffic data corresponding to the target test case is obtained from the server.

It should be understood that, before obtaining the recorded traffic data corresponding to the target test case from the server, the recording mobile terminal obtains the recorded traffic data after receiving the recording request for the target test case and stores the recorded traffic data in the server. Where, the recorded traffic data includes second response data and second request data.

In step b, based on a test requirement set, the preset request field is determined from the request fields of the second request data, and the preset response field is determined from the response fields of the second response data.

It should be understood that the test requirement set is used to record all the requirement information of the target application. In other words, the requirement information corresponding to all the test cases of the target application may be obtained by querying the test requirement set. Where, the requirement information is the information that specifies data such as the execution conditions, inputs and outputs, preset request fields and preset response fields of the test cases to implement the specific requirements. The requirement information may be changed based on the change in the requirement of the test case, i.e., testers may configure the requirement information as required. Therefore, based on the test requirement set, the preset request field may be determined from the request fields of the second request data, and the preset response field may be determined from the responses field of the second response data.

Further, in a case that the requirement information corresponding to the target test case changes, the test requirement set is updated synchronously. Consequently, the preset request field and preset response field are also modified in accordance with the changes in the test requirement set. Therefore, according to the embodiment of the present disclosure, the preset request field and preset response field corresponding to the target test case may be updated by re-recording the traffic data of the target test case.

In step c, the preset request field is associated with the preset response field to obtain a first association relationship.

It should be understood that the target test case may include more than one preset request field, and each preset request field may correspond to more than one preset response field. By associating the preset request field with the preset response field, the first association relationship is obtained. The preset response field corresponding to a preset request field may be determined rapidly after the preset request field corresponding to the target test case is identified in the first request data, which is beneficial to improving the test efficiency.

In an embodiment, the process of generating the target value corresponding to the preset response field in a case that the preset request field corresponding to the target test case is identified in the first request data includes:

in a case that a preset request field corresponding to the target test case is identified in the first request data, the preset response field corresponding to the preset request field is determined based on the first association relationship, and the target value corresponding to the preset response field is generated.

It should be understood that the first association relationship is an association relationship between a preset request field and a preset response field of the target test case. In an aspect, the target test case further includes multiple response fields in addition to the preset response field. In another aspect, there may be multiple preset request fields in the first request data and each preset request field may correspond to more than one preset response field. In a case that the quantity of the request fields and the quantity of the response fields of the first request data are significant, the preset response field corresponding to the preset request field can be determined rapidly based on the first association relationship, which can saving the time spent in identifying the preset request field and the preset response field.

In an embodiment, the process of determining the preset request field from the request fields of the second request data and determining the preset response field from the response fields of the second response data based on the test requirement set includes as follows.

In step d, the second request data is parsed and the requirement information corresponding to the target test case is determined from the test requirement set.

In step e, based on the requirement information corresponding to the target test case, the preset request field is determined from the request fields of the second request data, and the preset response field is determined from the response fields of the second response data.

It should be understood that, the request parameters corresponding to the second request data can be determined by parsing the second request data. The request parameter is matched with all test cases in the test requirement set. In a case that the requirement information of a test case can cover the request parameter, the test case is served as a target test case, to determine the requirement information corresponding to the target test case. Since the requirement information corresponding to the target test case specifies the preset request field and preset response field of the target test case, the preset request field may be determined from the request fields of the second request data, and the preset response field may be determined from the response fields of the second response data.

Further, the traffic data is from the test interfaces of the target application, where the target application includes multiple test interfaces, and each test interface may have multiple test cases. In order to improve readability of test requirement set and clarify correspondence relationship of requirement information, the test requirement set may be categorized by test interfaces. That is, test requirement set may record test case sets of all test interfaces, and one test case set corresponds to all test cases for one test interface.

In this embodiment of the present disclosure, the request address and request parameters corresponding to the second request data may be determined by parsing the second request data. A test interface corresponding to the request address may be determined as the target test interface from test interfaces of the test requirement set, and the test case set of the target test interface may be extracted as the target test case set. Then, the request parameters are matched with all test cases of the target test case set. A test case is served as the target test case in a case that the requirement information of the test case can cover the request parameters, thereby determining the requirement information corresponding to the target test case.

In an embodiment, the process of generating the target value corresponding to the preset response field includes: a target value corresponding to the preset response field is generated based on an assignment rule corresponding to the preset response field.

It should be understood that the assignment rule is used to specify the generation manner of target values. Each preset response field corresponds to an assignment rule, and the test requirement set records the assignment rules of the preset response fields corresponding to all test cases. Therefore, the assignment rule corresponding to the current preset response field may be determined based on the test requirement set. Subsequently, the target value corresponding to the preset response field is generated based on the assignment rule corresponding to the preset response field.

In an embodiment, the assignment rule includes a random rule. The process of generating the target value corresponding to the preset response field based on the assignment rule corresponding to the preset response field includes: generating a value randomly as the target value corresponding to the preset response field, in a case that the assignment rule corresponding to the preset response field is a random rule.

It should be understood that the random rule specifies that the target value is generated randomly. In a case that the assignment rule corresponding to the preset response field is the random rule, a value is generated randomly and it is ensured that the value is different from the value corresponding to the current preset response field. The value is then served as the target value corresponding to the preset response field.

In an embodiment, the assignment rules include a preset rule. In this case, the process of generating the target value corresponding to the preset response field based on the assignment rule corresponding to the preset response field includes: generating a value that satisfies the preset rule as the target value corresponding to the preset response field, in a case that the assignment rule corresponding to the preset response field is the preset rule.

It should be understood that the preset rule include a data type and a value range. The preset rule specifies that the target value is generated based on the data type and the value range. In a case that the assignment rule corresponding to the preset response field is the preset rule, the value that satisfies the data type and falls within the value range is generated as the target value corresponding to the preset response field.

A device for denoising test data according to the embodiment of the present disclosure is described below. The device for denoising test data described below and the method for denoising test data described above may be referred to each other.

In a second aspect, a device for denoising test data is provided according to embodiments of the present disclosure. Reference is made to FIG. 2. FIG. 2 illustrates a schematic diagram of modules of a device for denoising test data. As shown in FIG. 2, the device for denoising test data includes a test case replaying module 202, a target value generation module 204 and a target value replacement module 206 as follows.

The test case replaying module 202 is configured to obtain replaying traffic data for a replaying mobile terminal different from a recording mobile terminal in response to a replaying request for a target test case.

The target value generation module 204 is configured to generate a target value corresponding to the preset response field in a case that a preset request field corresponding to the target test case is identified in the first request data.

The target value replacement module 206 is configured to replace a value of a response field matching the preset response field in the first response data with the target value.

In an embodiment, the device for denoising test data further includes the following modules for implementing the generation process of the preset request field and preset response field corresponding to the target test case in the target value generation module 204.

A recording data obtaining module, configured to obtain the recorded traffic data corresponding to the target test case from a server.

A preset field determination module, configured to determine the preset request field from the request fields of the second request data and determine the preset response field from the response fields of the second response data, based on the test requirement set.

A preset field association module, configured to associate the preset request field and the preset response field to obtain the first association relationship.

In an embodiment, the target value generation module 204 may include:
a target value generation unit, configured to determine the preset response field corresponding to the preset request field based on the first association relationship in a case that the preset request field corresponding to the target test case is identified in the first request data, and generate the target value corresponding to the preset response field.

In an embodiment, the preset field determination module may include a request data parsing unit and a preset field determination unit.

The request data parsing unit is configured to parse the second request data and determine the requirement information corresponding to the target test case from the test requirement set.

The preset field determination unit is configured to determine the preset request field from the request fields of the second request data and determine the preset response field from the response fields of the second response data based on the requirement information corresponding to the target test case.

In an embodiment, the target value generation module 204 may include the target value generation unit, the target value generation unit is configured to generate the target value corresponding to the preset response field based on an assignment rule corresponding to the preset response field.

In an embodiment, the assignment rule includes a random rule. The target value generation unit may include a target value random generation sub-unit, which is configured to randomly generate a value as the target value corresponding to the preset response field, in a case that the assignment rule corresponding to the preset response field is the random rule.

In an embodiment, the assignment rule includes a preset rule. The target value generation unit may include a target value preset generation sub-unit, which is configured to generate a value that satisfies the preset rule as the target value corresponding to the preset response field, in a case that the assignment rule corresponding to the preset response field is the preset rule.

In an embodiment of the present disclosure, a storage medium is provided, where computer-readable instructions are stored thereon. The computer-readable instructions, when executed by one or more processors, cause one or more processors to implement the steps of the method for denoising test data according to any one of the embodiments of the present disclosure.

In an embodiment, a computer device is provided according to an embodiment of the present disclosure, the computer device stores computer-readable instructions thereon. The computer-readable instructions, when executed by one or more processors, cause the one or more processors to implement the steps of the method for denoising test data according to any one of the embodiments of the present disclosure.

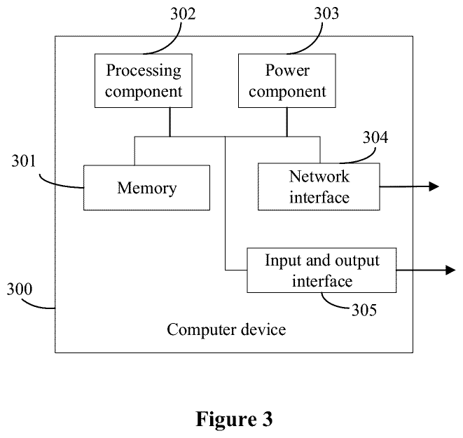

In an embodiment, as shown in FIG. 3, FIG. 3 is a schematic diagram of an internal structure of a computer device according to an embodiment of the present disclosure. The computer device 300 may be provided as a mobile terminal. Reference is made to FIG. 3. Where, the computer device 300 includes a processing component 302, which further includes one or more processors, and a memory resource represented by a memory 30. The memory resource is used for storing instructions such as an application program executed by the processing component 302. The application programs stored in memory 301 may include one or more modules each correspond to a set of instructions. In addition, the processing component 302 is configured to execute instructions to implement the method for denoising test data according to any one of embodiments described above.

The computer device 300 may further include a power component 303 configured to perform power management of the computer device 300, a wired or wireless network interface 304 configured to connect the computer device 300 to the network, and an input/output (I/O) interface 305. The computer device 300 may be operated in an operating system provided in the memory 301, such Android, IOS, and the like.

Based on the technical solutions described above, the embodiments of the present disclosure have advantages as follows.

According to the present disclosure, the method and device for denoising test data, the storage media and the computer device are provided. For any replaying mobile terminal different from the recording mobile terminal, the first request data and the first response data for replaying traffic data are obtained in response to the replaying request for the target test case. The first response data is the same as the response data for recording the target test case. Then, in a case that a preset request field corresponding to the target test case is identified in the first request data, a target value corresponding to the preset response field is generated, where the preset response field is corresponding to the preset request field. Ultimately, the value of the response field matching the preset response field in the first response data is replaced with the target value. According to the present disclosure, in a case that a preset request field corresponding to the target test case is identified in the first request data, it can be determined that a preset response field corresponding to the preset request field is included in the current first response data. The target value corresponding to the preset response field is generated, and the value of the response field matching the preset response field in the first response data is replaced with the target value. In this way, it can ensure that the first response data with replacement can be applicable to the replaying mobile terminal. Therefore, in a case that the test case is replayed on any one of replaying mobile terminals, the interference caused by the differences between mobile terminals can be eliminated, ensuring effectiveness of replaying traffic data, and improving efficiency of replaying test cases.

Those skilled in the art should understand that, the structure shown in FIG. 3 is only a block diagram of part of a structure correlated to the solutions according to the present disclosure and does not constitute a limitation to the computer device to which the solutions according to the present disclosure are applied. The specific computer device may include more components or fewer components than the components shown in the FIG. 3, or some components may be combined, or a different arrangement of components may be applied.

It should be further illustrated that a relation term such as “first” and “second” herein is only used to distinguish one entity or operation from another entity or operation, and does not necessarily require or imply that there is an actual relation or sequence between these entities or operations. In addition, the terms “comprise”, “include”, or any other variants thereof are intended to encompass a non-exclusive inclusion, such that the process, method, article, or device including a series of elements includes not only those elements but also those elements that are not explicitly listed, or the elements that are inherent to such process, method, article, or device. Unless explicitly limited, the statement “including a . . . ” does not exclude the case that other similar elements may exist in the process, the method, the article or the device other than enumerated elements.

The embodiments in this specification are described in a progressive way, each of which emphasizes the differences from others. The embodiments may be combined as required, and the same or similar parts among the embodiments may be referred to each other.

Based on the above description of the disclosed embodiments, those skilled in the art can implement or apply the present disclosure. Various modifications to the embodiments are obvious to those skilled in the art, and general principles defined in the present disclosure can be implemented in other embodiments without departing from the spirit or scope of the present disclosure. Hence, the present disclosure shall not be limited to the embodiments described herein, rather, has the widest scope that complies with the principle and novelty disclosed herein.

1. A method for denoising test data, performed by a processor, comprising:
obtaining, for a replaying mobile terminal different from a recording mobile terminal, replaying traffic data in response to a replaying request for a target test case, wherein the replaying traffic data comprises first request data and first response data, the first response data is the same as second response data, and the second response data is response data for recording the target test case:
generating a target value corresponding to a preset response field, in a case that a preset request field corresponding to the target test case is identified in the first request data, wherein the preset response field corresponds to the preset request field in the first request data, and the preset response field is a noise field:
replacing a value of a response field matching the preset response field in the first response data with the target value, to eliminate interference caused by the noise field during a process of replaying the target test case and enable the first response data with replacement to be applicable to the replaying mobile terminal; and
displaying the target test case on the replaying mobile terminal;
wherein a generation process of the preset request field and the preset response field corresponding to the target test case comprises:
obtaining recorded traffic data corresponding to the target test case from a server, wherein the recorded traffic data comprises the second response data and second request data:
parsing the second request data:
determining requirement information corresponding to the target test case from a test requirement set, wherein the test requirement set is used to record all the requirement information of a target application:
determining the preset request field from request fields of the second request data based on the requirement information corresponding to the target test case:
determining the preset response field from response fields of the second response data based on the requirement information corresponding to the target test case; and
associating the preset request field with the preset response field to obtain a first association relationship; and
wherein the generating the target value corresponding to the preset response field comprises:
generating the target value corresponding to the preset response field based on an assignment rule corresponding to the preset response field.

2. The method for denoising test data according to claim 1, wherein the process of generating the target value corresponding to the preset response field in a case that the preset request field corresponding to the target test case is identified in the first request data comprises:
determining, in the case that the preset request field corresponding to the target test case is identified in the first request data, the preset response field corresponding to the preset request field based on the first association relationship; and
generating the target value corresponding to the preset response field.

3. (canceled)

4. The method for denoising test data according to claim 1, wherein
the assignment rule comprises a random rule:
the process of generating the target value corresponding to the preset response field based on the assignment rule corresponding to the preset response field comprises:
generating a value randomly as the target value corresponding to the preset response field, in a case that the assignment rule corresponding to the preset response field is the random rule.

5. The method for denoising test data according to claim 1, wherein the assignment rule comprises a preset rule:
the process of generating the target value corresponding to the preset response field based on the assignment rule corresponding to the preset response field comprises:
generating a value that satisfies the preset rule as the target value corresponding to the preset response field, in a case that the assignment rule corresponding to the preset response field is the preset rule, wherein the preset rule comprises a data type and a value range.

6. (canceled)

7. A non-transitory storage medium, storing computer-readable instructions, wherein the computer-readable instructions, when executed by one or more processors, cause the one or more processors to implement a method for denoising test data, the method comprises:
obtaining, for a replaying mobile terminal different from a recording mobile terminal, replaying traffic data in response to a replaying request for a target test case, wherein the replaying traffic data comprises first request data and first response data, the first response data is the same as second response data, and the second response data is response data for recording the target test case:
generating a target value corresponding to a preset response field, in a case that a preset request field corresponding to the target test case is identified in the first request data, wherein the preset response field corresponds to the preset request field in the first request data, and the preset response field is a noise field:
replacing a value of a response field matching the preset response field in the first response data with the target value, to eliminate interference caused by the noise field during a process of replaying the target test case and enable the first response data with replacement to be applicable to the replaying mobile terminal; and
displaying the target test case on the replaying mobile terminal;
wherein a generation process of the preset request field and the preset response field corresponding to the target test case comprises:
obtaining recorded traffic data corresponding to the target test case from a server, wherein the recorded traffic data comprises the second response data and second request data:
parsing the second request data:
determining requirement information corresponding to the target test case from a test requirement set, wherein the test requirement set is used to record all the requirement information of a target application:
determining the preset request field from request fields of the second request data based on the requirement information corresponding to the target test case:
determining the preset response field from response fields of the second response data based on the requirement information corresponding to the target test case; and
associating the preset request field with the preset response field to obtain a first association relationship; and
wherein the generating the target value corresponding to the preset response field comprises:
generating the target value corresponding to the preset response field based on an assignment rule corresponding to the preset response field.

8. A computer device, comprising:
one or more processors; and
a memory, wherein the memory stores computer-readable instructions, and the computer-readable instructions, when executed by the one or more processors, implement the method for denoising test data according to claim 1.
